(19) United States
(12) Patent Application Publication
(10) Pub. No.: US 2011/0134180 A1
(43) Pub. Date: Jun. 9, 2011

(54) SYSTEM AND METHOD FOR CONTROLLING A TEMPERATURE OF A PRINTHEAD BY CONFIGURING ITS I/O PAD TO MULTI-TASK

(76) Inventors: Steven Wayne Bergstedt, Winchester, KY (US); Earl Lawrence Fugate, Lexington, KY (US)

(21) Appl. No.: 12/632,872

(22) Filed: Dec. 8, 2009

(51) Int. Cl. B41J 29/38

(52) U.S. Cl. 347/17

(57) ABSTRACT

A system and method for controlling a temperature of a printhead by configuring its I/O pad to multitask. In one embodiment of the invention, a system includes an I/O pad affixed to the printhead to supply a signal to a circuit disposed on the printhead, a controller to interrupt the supply of the signal to the circuit when the temperature of the printhead exceeds a predetermined value, a drive mechanism to drive the I/O pad to a ground level when the temperature of the printhead falls back below the predetermined value, and a polling circuit to measure an electric level of the I/O pad such that the controller reestablishes the supply of the signal to the circuit when a ground level is measured by the polling circuit thereby providing an efficient way to constantly monitor and control the temperature of the printhead.

### BACKGROUND

1. Field of the Invention

The present invention relates generally to a system and method for controlling a temperature of a printhead, and particularly to a system and method for controlling a temperature of a printhead having a single I/O pad.

2. Description of the Related Art

Image forming devices print an image by ejecting ink drops from a printhead at a desired location on a print media. A quality and consistency of the printed image, however, is dependent on a number of factors, such as ink temperature. Ink drop with a lower temperature have different mass and velocity from an ink drop with a higher temperature. Because the mass and velocity implicate where the ink drops are located on the print medium, if the temperature of the ink is not maintained properly, then the drops misdirect upon firing or are malformed before firing. A proper temperature of the ink drops is required to be maintained to avoid drop placement errors which cause poor or inconsistent print quality.

The temperature of ink drops is dependent on the temperature of the printhead. Therefore, it is required to monitor and control the temperature of the printhead. There are systems to control the temperature of the printhead. Generally, these systems use a reference temperature as a datum to control the temperature of the printhead. If the temperature of the printhead deviates from the reference temperature a fault state is indicated. For example, when the temperature of the printhead exceeds the reference temperature an over temperature state (OTS) is indicated.

If the printhead remains in the over temperature state for a long duration the printhead or the image forming device may get damaged permanently. Usually, a dedicated pin (an extra pin) is affixed to the printhead to indicate the over temperature state. In the over temperature state generally a voltage on the dedicated pin exceeds a predetermined value. When the voltage on the dedicated pin exceeds the predetermined value the OTS is indicated and an immediate action can be taken to reduce the temperature of the printhead. In some systems, the over temperature state is indicated by setting/resetting a particular bit in a data stream. When the temperature of the printhead exceeds the reference temperature the particular bit in the data stream is set/reset by a controller to indicate the OTS. In such systems, the OTS is detected by polling the data stream to check if the particular bit is set/reset.

However, the system that uses the particular bit to indicate the OTS fails to indicate the OTS until that bit is polled, and the delay in polling/detecting the over temperature state may damage the printhead or the image forming device. Further, the dedicated pin may be used to immediately detect/indicate the OTS, however the use of dedicated pin is expensive.

It would be desirable therefore to provide a system and method for controlling temperature of a printhead to obviate the above mentioned problems.

### SUMMARY OF THE INVENTION

Disclosed herein is a system for controlling a temperature of a printhead in an image forming device that includes an I/O pad affixed to the printhead to supply a signal to a circuit disposed on the printhead, a controller configured to interrupt the supply of the signal to the circuit when the temperature of the printhead exceeds a predetermined value, a drive mechanism coupled to the I/O pad to drive the I/O pad to a ground level when the temperature of the printhead falls back below the predetermined value, and a polling circuit configured to measure an electric level of the I/O pad such that the controller reestablishes the supply of the signal to the circuit when the ground level is measured by the polling circuit.

In a further form, the I/O pad includes a first input region, a second input region, and an output region such that the I/O pad operates in the first input region when the temperature of the printhead is below the predetermined value, operates in the second input region when the signal is supplied to the circuit, and operates in the output region when the temperature of the printhead exceeds the predetermined value.

In a further form, the first input region has a first voltage, the second input region has a second voltage, and the output region has a third voltage such that the third voltage is greater than the second voltage and the second voltage is greater than the first voltage.

In another embodiment, a switch is positioned between the I/O pad and the circuit and the switch is operable in an open and a closed state such that the controller drives the switch to the open state to interrupt the supply of the signal to the circuit and the controller drives the switch to the closed state to reestablish the supply of the signal to the circuit

In another aspect, a method for controlling the temperature of a printhead in an image forming device comprises supplying a signal to a circuit disposed on the printhead, sensing the temperature of the printhead by a temperature sensor disposed on the printhead, interrupting the supply of the signal by a controller when the sensed temperature exceeds a predetermined value, driving the I/O pad to a ground level by a drive mechanism when the temperature of the printhead falls back below the predetermined value, measuring an electric level of the I/O pad by a polling circuit and communicating the measured level to the controller, and reestablishing the supply of the signal by the controller when a ground level is measured by the polling circuit.

In yet another aspect, a printhead comprises a housing, a circuit affixed to the housing and operable to eject ink, an I/O pad affixed to the printhead to supply a signal to the circuit, a controller configured to interrupt and reestablish the supply of the signal to the circuit, the controller interrupts the supply of the signal when a temperature of the printhead exceeds a predetermined value and the controller reestablishes the supply of the signal when the temperature of the printhead falls back below the predetermined value, and a polling circuit configured to measure an electric level of the I/O pad and communicate the measured level to the controller such that a ground level is communicated to the controller when the temperature of the printhead falls back below the predetermined temperature.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The above-mentioned and other features and advantages of the various embodiments of the invention, and the manner of attaining them, will become more apparent will be better understood by reference to the accompanying drawings, wherein:

FIG. 1 is a block diagram of one embodiment of a system for controlling a temperature of a printhead according to the present invention;

FIG. 2 illustrates an I/O pad configured to operate in different regions and affixed to the printhead of FIG. 1 according to the present invention;

FIG. 3 illustrates an external power source supplying a signal to the I/O pad of FIG. 2; and

FIG. 4 is a flowchart illustrating the steps to control the temperature of the printhead of FIG. 1 according to the present invention.

### DETAILED DESCRIPTION

Reference will now be made in detail to the exemplary embodiment(s) of the invention, as illustrated in the accompanying drawings. Whenever possible, the same reference numerals will be used throughout the drawings to refer to the same or like parts.

The present invention is directed to a system and method for controlling a temperature of a printhead by configuring an I/O pad of the printhead to multi-task. FIG. 1 illustrates one embodiment of a system 100 to control a temperature of a printhead 110. The printhead 110 includes an I/O pad 120 to supply a signal to a circuit 130 disposed on the printhead 110. A controller 140 interrupts the supply of the signal from the I/O pad 120 if the temperature of the printhead 110 exceeds a predetermined value. When the temperature of the printhead 110 falls back below the predetermined value a drive mechanism 150 drives the I/O pad 120 to a ground level. Electric level of the I/O pad 120 is measured by a polling circuit 160. The polling circuit 160 communicates the measured electric level to the controller 140. When the ground level is measured by the polling circuit 160 the controller 140 reestablishes the supply of the signal from the I/O pad 120.

The I/O pad 120 is affixed to the printhead 110 preferably the I/O pad 120 is affixed to a periphery of the printhead 110. The I/O pad 120 supplies the signal to the circuit 130 disposed on the printhead 110. The circuit 130 includes a plurality of actuators and is operable to eject ink. The circuit 130 may be affixed to a housing 180 of the printhead 110. The circuit 130 is driven by the signal supplied from the I/O pad 120.

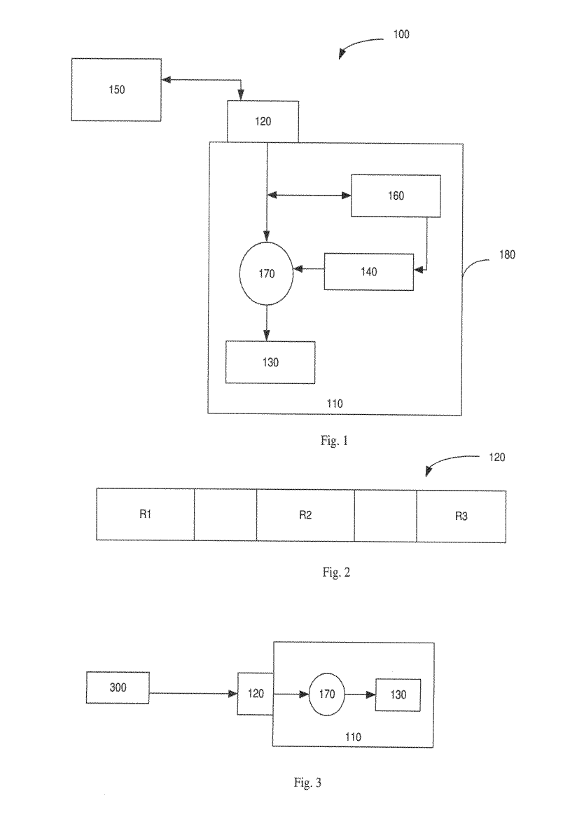

The I/O pad 120 is configured to operate in a first input region R1, a second input region R2, and an output region R3 (shown in FIG. 2). In normal operating condition, when the temperature of the printhead 110 is below the predetermined value the I/O pad 120 operates in the second input region R2 (shown in FIG. 2). While operating in the second input region R2 the I/O pad 120 supplies the signal to the circuit 130. The signal may be an electrical voltage or an electric current.

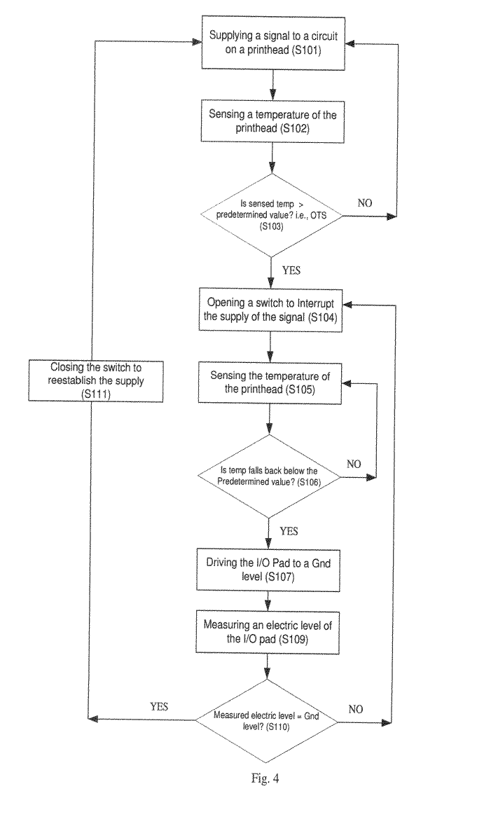

The I/O pad 120 supplies the signal to the circuit 130 through a switch 170. The switch 170 is positioned between the I/O pad 120 and the circuit 130. The switch 170 is operable in an open and a closed state. When the I/O pad 120 operates in the second input region R2 the switch 170 is in the closed state to enable the supply of signal from the I/O pad 120 to the circuit 130. Essentially, the I/O pad 120 receives the signal (to be supplied to the circuit 130) from a source 300 positioned external to the printhead 110 (shown in FIG. 3).

Gradually, when the temperature of the printhead 110 increases and exceeds the predetermined value the controller 140 drives the switch 170 to the open state to interrupt the supply of signal from the I/O pad 120. When the supply is interrupted the I/O pad 120 is driven into the output region R3 (shown in FIG. 2). In the output region R3, the I/O pad 120 operates in a third voltage V3. Essentially, the third voltage is the highest operating voltage of the I/O pad 120. The voltage V3 indicates the Over Temperature State (OTS).

After the indication of the OTS the drive mechanism 150 forcibly drives the I/O pad 120 into the first input region R1. The drive mechanism 150 is coupled to the I/O pad 120 and is disposed external to the printhead 110 within an image forming device (not shown). In one embodiment, the drive mechanism 150 drives the I/O pad 120 into the first input region R1 when the temperature of the printhead 110 falls back below the predetermined value. In another embodiment, the drive mechanism 150 drives the I/O pad 120 into the first input region R1 after a fixed time interval from the indication of the OTS. In the first input region R1 the I/O pad 120 operates in a first voltage V1. The first voltage is the lowest operating voltage of the I/O pad 120. Essentially, in the first input region R1 the I/O pad 120 is driven to a ground level.

Electric level of the I/O pad 120 is measured by the polling circuit 160. The electric level may be a voltage level or a current level. The polling circuit 160 is disposed on the printhead 110 to measure the electric level of the I/O pad 120. The polling circuit 160 communicates the measured electric level to the controller 140. When the ground level is measured by the polling circuit 160 the controller 140 reestablishes the supply of the signal to the circuit 130. Essentially, the controller 140 closes the switch 170 to reestablish the supply of the signal to the circuit 130.

When the supply is reestablished the I/O pad 120 starts operating in the second input region R2. In the second input region R2 the I/O pad 120 operates in a second voltage V2 to supply the signal to the circuit 130. The second voltage V2 is an optimum operating voltage of the I/O pad 120. Generally, the second voltage V2 is in between the first voltage V1 and the third voltage V3. In one embodiment, the first voltage V1 lies between about 0 volt to about 0.25 volts, the second voltage V2 lies between about 1 volt to about 2 volts, and the third voltage V3 is above about 3 volts.

FIG. 4 is a flowchart illustrating a method for controlling the temperature of the printhead 110 within the image forming device. During normal operating condition, the I/O pad 120 supplies the signal to the circuit 130 disposed on the printhead 110 (step S101). The printhead 110 includes a temperature sensor (not shown) that senses the temperature of the printhead 110 (step S102). If the sensed temperature is greater than the predetermined value i.e., if the OTS is detected (step S103: YES), the controller 140 opens the switch 170 to interrupt the supply of the signal from the I/O pad 120 (step S104). The temperature sensor keeps sensing the temperature of the printhead 110 (step S105). If the temperature of the printhead 110 decreases and falls back below the predetermined value (step S106: YES) the drive mechanism 150 drives the I/O pad 120 to the ground level (step S107). The electric level of the I/O pad 120 is measured by the polling circuit 160 (step S108). The polling circuit 160 communicates the measured electric level to the controller 140. If a ground level is measured by the polling circuit 160 (step S109: YES) then the controller 140 drives the switch 170 to the close sate to reestablish the supply of signal to the circuit (step S110) and the loop from step S101 to step S109 continues. In case the measured electric level is not equal to the ground level (step S104: NO) then the controller 140 keeps the supply of the signal interrupted (step S104) and the loop from step S105 to step S109 continues.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A system for controlling a temperature of a printhead in an image forming device comprising:
an I/O pad connected to the printhead, the I/O pad supplying a signal to a circuit disposed on the printhead;
a controller configured to interrupt the supply of the signal to the circuit when the temperature of the printhead exceeds a predetermined value;
a drive mechanism connected to the I/O pad to drive the I/O pad to a ground level when the temperature of the printhead falls back below the predetermined value; and
a polling circuit configured to measure an electric level of the I/O pad, wherein the controller reestablishes the supply of the signal to the circuit when the ground level is measured by the polling circuit.

2. The system for controlling a temperature of a printhead of claim 1, wherein the circuit includes a plurality of actuators and the signal is one of: (i) an electrical voltage and (ii) an electric current.

3. The system for controlling a temperature of a printhead of claim 1, wherein the polling circuit is disposed on the printhead and the drive mechanism is disposed external to the printhead within the image forming device.

4. The system for controlling a temperature of a printhead of claim 1, further comprising a switch positioned between the I/O pad and the circuit, the switch being operable in an open and a closed state such that the controller drives the switch to the open state to interrupt the supply of the signal to the circuit and the controller drives the switch to the closed state to reestablish the supply of the signal to the circuit.

5. The system for controlling a temperature of a printhead of claim 1, wherein the signal being supplied to the circuit is received from a source external to the printhead. The system for controlling a temperature of a printhead of claim 1, wherein the I/O pad includes a first input region, a second input region, and an output region such that the I/O pad operates in the first input region when the temperature of the printhead is below the predetermined value, the second input region when the signal is supplied to the circuit, and the output region when the temperature of the printhead exceeds the predetermined value.

6. The system for controlling a temperature of a printhead of claim 1, wherein the first input region having a first voltage, the second input region having a second voltage, and the output region having a third voltage such that the third voltage is greater than the second voltage and the second voltage is greater than the first voltage.

7. The system for controlling a temperature of a printhead of claim 1, wherein the electric level is one of: (i) a voltage level and (ii) a current level.

8. A method for controlling the temperature of a printhead in an image forming device comprising:
supplying a signal to a circuit disposed on the printhead;
sensing the temperature of the printhead by a temperature sensor disposed on the printhead;
interrupting the supply of the signal by a controller when the sensed temperature exceeds a predetermined value;
driving an I/O pad to a ground level by a drive mechanism when the temperature of the printhead falls back below the predetermined value;
measuring an electric level of the I/O pad by a polling circuit and communicating the measured level to the controller; and
reestablishing the supply of the signal by the controller when a ground level is measured by the polling circuit.

9. The method for controlling the temperature of a printhead of claim 8, wherein the circuit includes a plurality of actuators and the signal is one of: (i) an electrical voltage and (ii) an electric current.

10. The method for controlling the temperature of a printhead of claim 9, further comprising opening a switch provided between the I/O pad and the circuit by the controller to interrupt the supply of the signal to the circuit and closing the switch by the controller to reestablish the supply of the signal to the circuit.

11. The method for controlling the temperature of a printhead of claim 9, wherein the electric level is one of: (i) a voltage level and (ii) a current level.

12. A printhead comprising:
a housing;
a circuit affixed to the housing and operable to eject ink;
an I/O pad affixed to the printhead, the I/O pad supplying a signal to the circuit;
a controller configured to interrupt and reestablish the supply of the signal to the circuit, the controller interrupts the supply of the signal when a temperature of the printhead exceeds a predetermined value and the controller reestablishes the supply of the signal when the temperature of the printhead falls back below the predetermined value; and
a polling circuit configured to measure an electric level of the I/O pad and communicate the measured level to the controller, wherein a ground level is communicated to the controller when the temperature of the printhead falls back below the predetermined temperature.

13. The printhead of claim 12, wherein the circuit includes a plurality of actuators and the signal is one of: (i) an electrical voltage and (ii) an electric current.

14. The printhead of claim 13, wherein when the temperature of the printhead falls back below the predetermined value an external drive mechanism drives the I/O pad to the ground level.

15. The printhead of claim 13, wherein the I/O pad includes a first input region, a second input region, and an output region such that the I/O pad operates in:
the first input region when the temperature of the printhead is below the predetermined value;
the second input region when the signal is supplied to the circuit; and
the output region when the temperature of the printhead exceeds the predetermined value.

16. The printhead of claim 13, wherein the first input region having a first voltage, the second input region having a second voltage, and the output region having a third voltage such that the third voltage is greater than the second voltage and the second voltage is greater than the first voltage.

17. The printhead of claim 13, wherein the electric level is one of: (i) a voltage level and (ii) a current level.
